(19) United States
(12) Patent Application Publication
(10) Pub. No.: US 2011/0283443 A1
(43) Pub. Date: Nov. 24, 2011

(54) TRANSPARENT, BIODEGRADABLE, PROTECTIVE SCREENS AND USES THEREOF

(75) Inventor: Deron Simpson, Finksburg, MD (US)

(73) Assignee: ASTIC Signals Defenses L.L.C., Owings Mills, MD (US)

(21) Appl. No.: 13/114,657

(22) Filed: May 24, 2011

Related U.S. Application Data
(60) Provisional application No. 61/347,625, filed on May 24, 2010.

(51) Int. Cl. A42B 3/04; B32B 7/02; A42B 3/22

(52) U.S. Cl. 2/424; 428/212

(57) ABSTRACT

The present invention provides a transparent, removable, biodegradable material for use on eyewear, computer screens, touch sensitive devices, mobile phones, and the like. Because the material is transparent, it can provide protection for eyewear or devices such as laptops and mobile phones without obscuring vision or display. Because the material is biodegradable, it can be safely discarded no matter the location, thereby reducing cleanup and disposal costs. The biodegradable nature of the material greatly extends its range of uses to include uses such as road motorcycling, search and rescue use, medical uses, mountain biking, vehicle windscreen protection such as for helicopters, skydiving, parasailing, sailing, laptops and mobile phone use, caving, potholing, spelunking, cave diving, a wide variety of military uses, protection in conditions such as sandstorms, and other activities where biodegradable, transparent, removable screens would be advantageous.

### BACKGROUND

I. Field of the Invention

The invention relates to transparent, biodegradable materials that can be attached to eyewear, computer screens, mobile phones, vehicle windscreens and the like and then removed when vision becomes obscured.

II. Description of Related Art

When eyewear is worn in an environment where it may become muddy or damaged, disposable lenses are often used. For example, multiple disposable lenses placed on eyewear enable a user to clear their vision by removing the dirty or damaged lens. In motorsport, for example, disposable lenses such as these are often referred to as “tear off” lenses because of the ability of the wearer to tear the lens off with minimal fuss.

For example, during motocross riding, disposable, tear off lenses are mounted on helmets or goggles so that the rider can remove them when his vision becomes obscured. Throughout a race, a rider may remove multiple lenses, discarding each on the track. After the race, race track owners must invest considerable time and resources removing the tear offs from the race course and surrounding area. After cleanup, the tear offs still have to be disposed of, creating further expense. Further, depending upon the tear off material, their disposal may create environmental issues such as due to leaching of toxic chemicals, increased waste buildup in landfills, etc. The non biodegradable nature of prior art disposable lenses limits their use to situations where they can be easily recovered for safe disposal. Thus, a need exists for a transparent, biodegradable material that can be used to protect eyewear, computer screens or other materials and can be removed and discarded in a wide variety of environments without the need for clean up or disposal.

### SUMMARY

The present invention provides a transparent, biodegradable material for use on eyewear, computer screens, touch sensitive devices, mobile phones, and the like. Because the material is transparent, it can provide protection for eyewear or devices such as laptops and mobile phones without obscuring vision or display. Because the material is biodegradable, it can be safely discarded no matter the location, thereby reducing cleanup and disposal costs. The biodegradable nature of the material greatly extends its range of uses to include uses such as road motorcycling, search and rescue use, medical uses, mountain biking, vehicle windscreen protection such as for helicopters, skydiving, parasailing, sailing, laptops and mobile phone use, caving, potholing, spelunking, cave diving, a wide variety of military uses, protection in conditions such as sandstorms, and other activities where biodegradable, transparent, removable screens would be advantageous.

The material of the invention may be water resistant to aid its use in these activities. As another example, the material may resist degradation for a period of time before beginning to degrade. The material may also biodegrade only upon exposure to a catalyst or other biodegradation initiating chemical. Or the material may degrade initially at a slow rate before accelerating its rate of degradation. Further, the material may degrade at steady but slow rate or at a fast but steady rate, as needed.

The transparent, biodegradable material of the present invention is designed for use with transparent screens, such as helmet and headgear visors, eyewear, vehicle windshields and windscreens, and electronic display screens. Transparent screens of the electronic display screen type may include laptop screens, computer screens, mobile phone screens, touch sensitive display screens, and the like.

For example, during inclement weather, a motorcycle user's helmet visor may become obscured due to dirt, oil, or the like. The visor may act as a lens or a shield, or both. Currently, motorcycle riders traveling on public roads are unable to use disposable, tear off lenses because they are not biodegradable and, thus, discarding them while riding would constitute littering and also harm the environment. The biodegradable material of the invention would solve this problem, enabling the rider to safely remove a lens and dispose of it without harming the environment. This would increase the safety of riding during inclement weather for road motorcycles users, such as civilians, police officers or military personnel. This would also be advantageous for off road motorcycling or mountain bike users.

The material of the invention may be transparent so that, when multiple layers of the material are placed on top of each other, the vision of the user is not unduly impaired. The biodegradable material used in the layers may also offer light control, and can be clear or tinted. The material may offer light control down to 1% or may be clear and allow all light to pass through. Light control may be obtained through use of biodegradable dyes with the biodegradable material. For example, if multiple layers were placed on the visor of a motocross rider, they would be transparent enough to enable the rider to operate his vehicle. The material of the invention may also be laminated together in order to improve transparency. However, the material need not be laminated in order for it to function as a transparent, biodegradable lens or screen. For example, the material may simply be layered onto eyewear, a windshield, a computer screen or other material being covered without being laminated or treated in any other way.

Further, the use of computers, mobile phones and the like in extreme or unpredictable weather conditions such as those found on oil rigs, fishing ships, or military vehicles creates the need for a transparent screen to protect against dirt and damage. In these situations, a biodegradable material would have the advantage of reduced clean up and disposal, which can be expensive due to the remote location of activities such as these. For example, the material of the invention could be used on a screen of vehicles such as helicopters or motor vehicles for protection in sandstorms or other weather likely to obscure vision or cause damage to windshields or the vehicle body. Further, the material may be used for personal use to protect delicate paint work or the like on vehicles. The material may be used on surfaces that are exposed to the elements or are otherwise subject to damage. The material may be used to protect from damage due to weathering, or may be used on surfaces that are subject to significant contact, risk of damage, or wear. For example, the material may be used on one or both sides of the transparent glass or polycarbonate/plastic panels that surround hockey rinks and other athletic surfaces in order to separate the players from the audience.

As another example, military and rescue personnel in extreme weather conditions and remote locations, such as sandstorms in the desert or storms at sea would benefit from a removable, transparent, biodegradable protective screen for their eyewear, computer screens and the like.

In another example, the material of the invention could be used by medical professionals to protect eyewear or medical devices during operations or when providing emergency medical care. The transparent, biodegradable material of the invention would be particularly useful when medical care must be provided in remote locations or in harsh working conditions such as during a national disaster. The material of the invention may provide protection for eyewear of the caregiver during use and then be safely and easily disposed due to its biodegradable nature.

The transparent, biodegradable material of the invention may alone, or in combination with other material(s), provide protection against emission of electromagnetic radiation. For example, by placing the material of the invention on a computer or television screen the emission or transmission of electromagnetic radiation may be reduced. For instance, the material may reduce the emission or transmission of infrared (IR) radiation. The material of the invention may provide security against compromising emanations and may be capable of being certified as providing such security under applicable testing standards. The material of the invention may also be placed on cables, wires, LEDs, keyboards or any other material that may need protection from emission or transmission of electromagnetic radiation.

The foregoing examples are intended to be illustrative and in no way limit the invention as claimed to only those uses. For example, the material of the invention may be used in analogous situations by the logging industry, the coast guard, or other rescue entities, or in everyday situations by cell phone or computer users who desire to protect their screen without harming the environment.

The removable screens and lenses of the current invention may be made from biodegradable, transparent materials. For example, transparent, biodegradable plastics may be used. The screens may be made from one or a combination of the following: corn starch based plastics, polylactic acid (PLA) plastics, cellulose acetate, cellulose blends, cellulose esters, polyvinyl alcohol, thermoplastics, polyesters, transparent biodegradable polycarbonate, carboxylic acid esters, biodegradable plastic resins, poly-3-hydroxybutyrate or other transparent, biodegradable materials. In the alternative, the transparent, biodegradable material of the invention may be made from a genetically modified plant material, such as genetically modified corn starch. Further, the material of the invention may be manufactured via an additive that converts a non biodegradable material into a biodegradable one.

The invention may also include a biodegradable adhesive to attach the material of the invention to goggles, helmets, computer screens or any other material in need to a transparent biodegradable layer. Cellulose tape or adhesives made from natural sources may be used for this purpose, although any adhesive sufficiently biodegradable and transparent would suffice. If minimal adhesive is used, or if it is used only at certain locations, then the adhesive need not be as transparent as the lens/screen material. In fact, the adhesive need not be transparent at all. For example, if the adhesive is only placed out of the line of sight of the eyewear/screen then the adhesive need not be transparent at all. The adhesive should be strong enough to hold the layers together during use but also pliant enough to allow easy removal of a layer by hand without tearing or unintentionally removing multiples layers.

The material of the invention may be removeably attached by other means that do not rely on an adhesive. For example, by physical means including tabs, buttons, ties, magnets, hooks or the like. Additionally, static or friction may be used to attach the biodegradable, transparent and removable lenses or screens made from the material of the present invention.

In another embodiment, the material of the invention may include a low tack pressure sensitive adhesive (PSA) on a film. These films may be capable of being used on a touch sensitive device, such as the screen of a mobile phone. The material of the invention may function with touch sensitive devices that rely upon physical touch, resistive displays, capacitive displays, or some combination. For example, certain devices may function via the proximity of an object, such as a finger or pointer, altering the electromagnetic field near the device. Embodiments of the invention including low tack PSA on a film are not limited to being used with touch sensitive devices, however. These embodiments may also be used on other devices disclosed herein, such as goggles. Further, these embodiments may involve multiple layers of films as discussed herein.

The device protected by the transparent, biodegradable material of the present invention may be a cell phone or other portable electronic device including a display screen. The cell phone or portable electronic device may include a keypad or touch-sensitive area for entering data and allowing the user to provide commands to the device. The transparent, biodegradable material may be used to protect both the display screen area and also the keypad or touch-sensitive area of such devices. The layers of the transparent, biodegradable material may be shaped to match the dimensions of the display screen of a cell phone or electronic device, and may also be shaped to cover a keypad or touch sensitive area. When covering a keypad or touch sensitive area, the transparent, biodegradable material may be flexible or may contain indentations to allow for individual coverage of each key or area without affecting a user's ability to operate the keypad or touch sensitive area.

The material of the invention may biodegrade due to exposure to oxygen, ultra violet light, microbes, bacteria, or any other environment or chemical that causes decomposition. For example, the transparent material of the invention may be biodegradable in one or more of the following environments, alone or in combination: landfills, home composting, industrial composting, soil, sewage sludge, waste water, anaerobic environments, aerobic environments, ultra violet light and any other environment such that the material decomposes. Also, the material may biodegrade after a chemical is added to destabilize it and initiate decomposition. The material may also biodegrade spontaneously without exposure to any chemical or particular degrading environment. The material of the invention may biodegrade partially on its own and then require further exposure or processing to complete degradation.

### DETAILED DESCRIPTION OF THE FIGURES

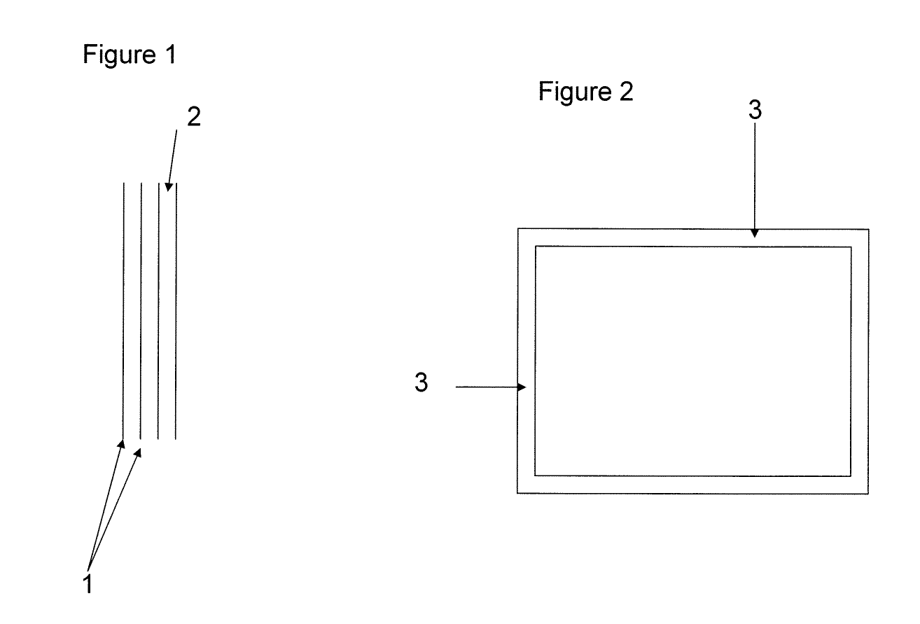

FIG. 1 shows a schematic side view of one embodiment of the invention containing multiple layers of transparent, biodegradable material 1. The layers of the invention may be joined together by an adhesive distributed in the area 2 between layers of biodegradable material 1. The adhesive may cover the entire surface of the material or it may be placed in discrete locations. For example, FIG. 2 is a schematic of a single layer of the material. In the embodiment of FIG. 2, the adhesive is only placed near the edge of the layer 3. In still other embodiments, the adhesive may be placed out of the line of sight of the user. While FIG. 2 depicts a rectangular sheet of transparent biodegradable material, the invention is not limited to this shape. In fact, the material may be made in custom shapes, for example, to fit on goggles, windscreens, or touch screen devices of a variety of shapes.

Instead of using an adhesive to join together the layers of the invention and also to attach the layers to transparent screen or device, the biodegradable material may also be attached without the use of adhesive. In one embodiment, the transparent, biodegradable material may be a biodegradable plastic material and the attachment between layers and to a device may be achieved by static or friction. In another embodiment, the attachment may be achieved by tabs, buttons, hooks, ties, or the like.

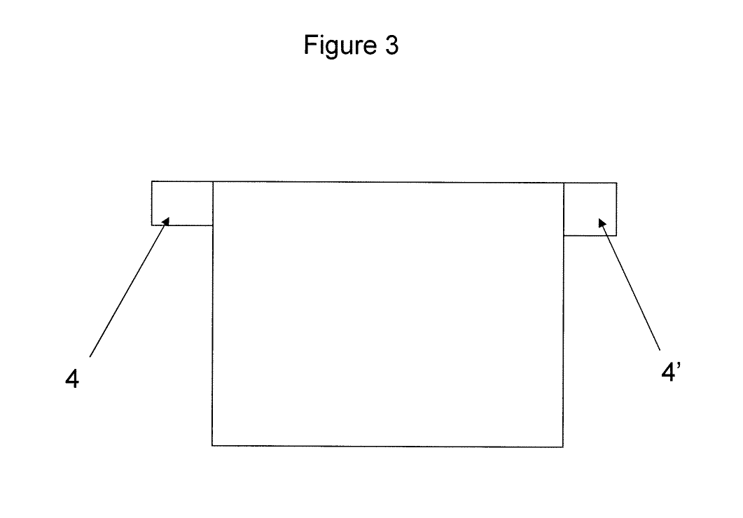

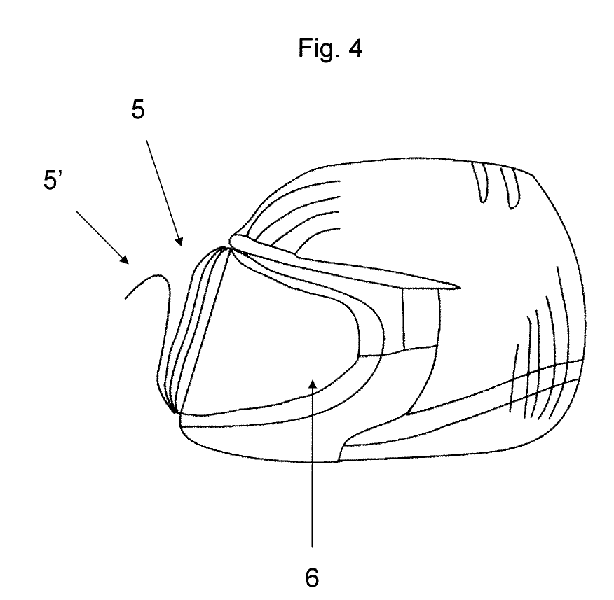

FIG. 3 is a schematic of another embodiment of the invention. This embodiment is also made of transparent biodegradable material and includes tabs 4 and 4′. These tabs may be used for one or more of: attaching multiple layers together to create a stack of layers, removing a layer, attaching a stack or single layer to the object in need of the transparent, biodegradable material (such as a motorcycle visor, cell phone, or helicopter windscreen). Tabs may be used in conjunction with an adhesive or without. The tabs in the figure are located on one corner of the screen, but, in other embodiments, they may be placed in any location that facilitates these functions, such as along the entire edge of the screen or along one border. Similarly, any number of tabs may be used.

FIG. 4 shows an embodiment of the invention. In this embodiment, a stack of layers 5 may be placed on the visor 6 of a motorcycle helmet. The helmet may include an outer protective shell surrounding inner protective material, wherein the inner protective material is attached to the outer shell. The outer shell may be made from plastics or fiber materials. The inner protective material may be made from fabric or foam materials, and is designed to cushion or crush on impact to prevent head injuries. The visor may be an integral part of the helmet, permanently affixed to the helmet, or may be removably attached to the motorcycle helmet. Tabs, adhesive, friction, static, or some combination may be used to attach the screen(s) to the helmet. The adhesive and the tabs may be located out of the line of sight of the helmet. The outer layer 5′ of the stack of layers may be removed by the user. While FIG. 4 shows a stack of layers, a single layer may also be used.

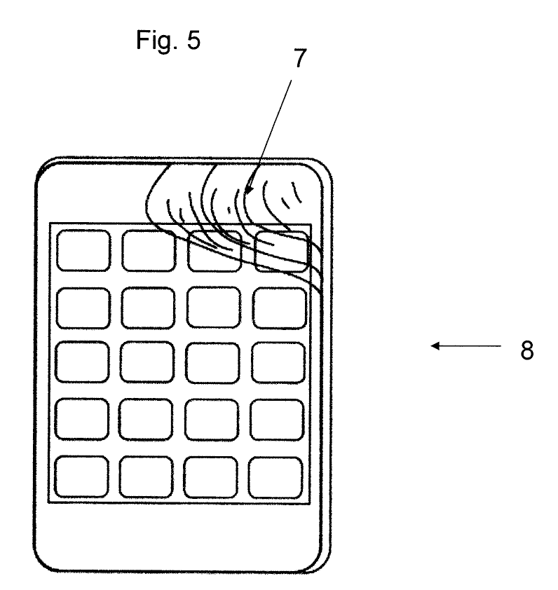

FIG. 5 show an embodiment of the invention that may be used with a touch screen device 8, such as a cell phone. The transparent, biodegradable screen 7 is placed over the screen of the device 8. This embodiment may use a pressure sensitive adhesive, or the like, and would allow use of the touch screen while protecting it with a transparent, biodegradable film. A layer of screens 7 may be used, as shown in the Figure, or a single transparent biodegradable screen may used.

Because various changes could be made in the above products and methods without departing from the scope of the invention, it is intended that all matter contained in the above description shall be interpreted as illustrative and not in a limiting sense.

What is claimed is:

1. A protective cover for a device containing a transparent screen, comprising:
a transparent, biodegradable material, wherein the material is formed in at least one layer; and
wherein the at least one layer is removably attached to the transparent screen.

2. The protective cover of claim 1, further comprising a biodegradable adhesive attaching the transparent, biodegradable material to the device, wherein the adhesive removably attaches the transparent, biodegradable material to the device

3. The protective cover of claim 2, wherein the transparent, biodegradable material includes a plurality of transparent layers, wherein each layer is removably attached to the layer below it by the biodegradable adhesive material.

4. The protective cover of claim 3, wherein the adhesive material is pliant and allows for the removal of a single layer of transparent, biodegradable material while leaving the remaining layers attached to the device.

5. The protective cover of claim 1, wherein the transparent, biodegradable material formed in at least one layer is a single layer attached to the device.

6. The protective cover of claim 1, wherein the transparent, biodegradable material is a low tack pressure sensitive adhesive on a film configured to be used with touch screen or touch-sensitive devices.

7. The protective cover of claim 6, wherein pressure sensitive adhesive on a film interacts with touch sensitive devices that rely on physical touch, resistive displays, capacitive displays, or combinations thereof.

8. The protective cover of claim 1, wherein the transparent, biodegradable material formed in at least one layer is a plurality of separate layers of transparent, biodegradable material attached to the device.

9. The protective cover of claim 8, where in the layers are joined together by an adhesive.

10. The protective cover of claim 9, wherein the adhesive covers the entire surface of each layer of transparent, biodegradable material.

11. The protective cover of claim 9, wherein the adhesive covers discrete areas of the surface of each layer of transparent, biodegradable material.

12. The protective cover of claim 8, wherein each layer of transparent, biodegradable material includes at least one tab located at an edge of the layer.

13. The protective cover of claim 12, wherein the at least one tab does not contain adhesive material, and wherein the tab is located so as to enable a user to remove the layer of transparent, biodegradable material by pulling on the tab.

14. The protective cover of claim 1, wherein the transparent, biodegradable material comprises biodegradable plastics.

15. The protective cover of claim 1, wherein the transparent, biodegradable material comprises genetically modified plant material.

16. The protective cover of claim 1, wherein the transparent, biodegradable material biodegrades due to exposure to oxygen, ultraviolet light, microbes, bacteria, chemical additive, or heat.

17. The protective cover of claim 1, wherein the device containing a transparent screen is a motorcycle helmet, cell phone, touch screen device, vehicle, computer, or eyewear.

18. A motorcycle helmet comprising:
an outer shell;
inner protective materials located inside of and attached to the outer shell;
a visor; and
a transparent, biodegradable material comprising at least one layer deposited on the visor.

19. The motorcycle helmet of claim 18, wherein the at least one layer of transparent, biodegradable material comprises a plurality of layers joined together to form a stack of layers on the visor, with the bottom layer attached to the helmet.

20. The motorcycle helmet of claim 19, wherein each of the plurality of layers is removable from the stack of layers.

21. The motorcycle helmet of claim 20, wherein the outer layer of the stack is removable from the stack without disengaging any other layer from the helmet.

22. The motorcycle helmet of claim 19, wherein each layer is removably attached to the layer below it by a biodegradable adhesive material.

23. The motorcycle helmet of claim 18, wherein each layer contains at least one tab positioned to enable a user to pull the tab to remove the layer from the helmet.

24. The motorcycle helmet of claim 18, wherein the at least one layer of transparent, biodegradable material is attached to the helmet by one or more tabs.

25. The protective cover of claim 1, wherein the device containing a transparent screen is a cellular phone or portable electronic device.

26. The protective cover of claim 25, wherein the transparent, biodegradable material formed in at least one layer is shaped to be the same dimensions as the transparent screen.

27. The protective cover of claim 25, wherein the transparent, biodegradable material formed in at least one layer is additionally attached to a keypad or touch-sensitive area of the cellular phone or portable electronic device.
